(19) United States
(12) Patent Application Publication
(10) Pub. No.: US 2026/0086480 A1
(43) Pub. Date: Mar. 26, 2026

(54) BELT UNIT AND IMAGE FORMING APPARATUS

(71) Applicant: FUJIFILM Business Innovation Corp., Tokyo (JP)

(72) Inventors: Takuma ISHIHARA, Kanagawa (JP); Takashi MATSUBARA, Kanagawa (JP); Takashi OHASHI, Kanagawa (JP); Motoharu NAKAO, Kanagawa (JP); Hina SAITO, Kanagawa (JP)

(73) Assignee: FUJIFILM Business Innovation Corp., Tokyo (JP)

(21) Appl. No.: 19/017,747

(22) Filed: Jan. 12, 2025

(30) Foreign Application Priority Data
Sep. 24, 2024 (JP) 2024-164835

(51) Int. Cl. G03G 15/20

(52) U.S. Cl. CPC G03G 15/205; G03G 15/2032; G03G 15/2064; G03G 2215/2025

(57) ABSTRACT

A belt unit includes an endless member that is rotated, a support member that supports the endless member in a bent posture at an end portion of the support member in a rotation direction of the endless member, a counter member that is disposed to face the support member with the endless member interposed therebetween and is in contact with the endless member at a predetermined contact pressure, a posture changing section that changes a posture of a bent portion of the endless member, and a control unit that controls the posture changing section to change a posture of the endless member to a posture in which bending of the bent portion of the endless member is reduced in a case where rotation of the endless member ends.

### CROSS-REFERENCE TO RELATED APPLICATIONS

This application is based on and claims priority under 35 USC 119 from Japanese Patent Application No. 2024-164835 filed Sep. 24, 2024.

### BACKGROUND

### (i) Technical Field

The present invention relates to a belt unit and an image forming apparatus.

### (ii) Related Art

Techniques disclosed in JP2011-81079A and JP2020-71350A to be described below are publicly known with regard to a fixing device that heats and fixes an unfixed image on the surface of a medium in an image forming apparatus.

JP2011-81079A (Paragraphs [0050] to [0118]) discloses a fixing device in which a heating belt (140) and a pressure belt (120) are disposed to face each other. In JP2011-81079A, the heating belt (140) and the pressure belt (120) are in pressure contact with each other during a fixing operation. After the formation of an image ends, the pressure belt (120) is rotated by an angle of 10° around a downstream end thereof and is shifted to a standby state where the pressure belt (120) is separated from the heating belt (140). In the standby state, the heating and rotation of the heating belt (140) continue. In a case where one minute has passed from the standby state, the pressure belt (120) returns to a position corresponding to an angle of 3° and is shifted to a sleep state. In the sleep state, the heating and the rotation of the heating belt (140) are stopped. In a case where the formation of a new image is started from the sleep state, the heating belt (140) returns to a position corresponding to an angle of 0.8° and performs an operation for preparing heating and rotation.

JP2020-71350A (Paragraphs [0021] and [0044] to [0075]) discloses a fixing device in which a belt (310) is supported by a heating roller (340), a pad (320), and a steering roller (350). In JP2020-71350A, in a case where the belt (310) is stopped at a temperature higher than or equal to a glass transition temperature and is then stopped for a predetermined time at a temperature lower than the glass transition temperature, the belt (310) is rotated while being heated. In this manner, the tendency of a surface release layer occurring at a temperature lower than the glass transition temperature is suppressed.

### SUMMARY

Aspects of non-limiting embodiments of the present disclosure relate to a fixing device and an image forming apparatus that suppress the tendency of an endless member to be bent as compared to a case where a posture of the endless member is fixed at the time of the stop of the rotation of the endless member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a belt unit including: an endless member that is rotated; a support member that supports the endless member in a bent posture at an end portion of the support member in a rotation direction of the endless member; a counter member that is disposed to face the support member with the endless member interposed therebetween and is in contact with the endless member at a predetermined contact pressure; a posture changing section that changes a posture of a bent portion of the endless member; and a control unit that controls the posture changing section to change a posture of the endless member to a posture in which bending of the bent portion of the endless member is reduced in a case where rotation of the endless member ends.

### BRIEF DESCRIPTION OF THE DRAWINGS

Exemplary embodiment(s) of the present invention will be described in detail based on the following figures, wherein:

FIG. 1 is an overall view of an image forming apparatus according to Example 1 of the present invention;

FIGS. 2A and 2B are enlarged views of a fixing device of Example 1 in which FIG. 2A is a diagram showing a state where a support member is moved to a first position and FIG. 2B is a diagram showing a state where the support member is moved to a second position;

FIGS. 3A and 3B are enlarged views of a fixing device of Example 2 corresponding to FIGS. 2A and 2B of Example 1 in which FIG. 3A is a diagram showing a state where a support member is moved to a first position and FIG. 3B is a diagram showing a state where the support member is moved to a second position; and

FIGS. 4A and 4B are enlarged views of a fixing device of Example 3 corresponding to FIGS. 2A and 2B of Example 1 in which FIG. 4A is a diagram showing a state where a posture changing section is moved to a first position and FIG. 4B is a diagram showing a state where the posture changing section is moved to a second position.

### DETAILED DESCRIPTION

Examples as specific examples of an exemplary embodiment of the present invention will be described below with reference to the drawings, but the present invention is not limited to Examples to be described below.

In order to facilitate the understanding of the following description, in the drawings, a front-rear direction will be referred to as an X-axis direction, a right-left direction will be referred to as a Y-axis direction, and a vertical direction will be referred to as a Z-axis direction. Directions or sides indicated by arrows X, −X, Y, −Y, Z, and −Z will be defined as a forward direction, a rearward direction, a rightward direction, a leftward direction, an upward direction, and a downward direction, or a front side, a rear side, a right side, a left side, an upper side, and a lower side, respectively.

Further, in the drawings, a symbol “○” with a symbol “ ” therein means an arrow from the back of the plane of the sheet to the front thereof and a symbol “○” with a symbol “×” therein means an arrow from the front of the plane of the sheet to the back thereof.

In the following description using the drawings, members other than members required for description will be appropriately omitted to facilitate understanding.

### Example 1

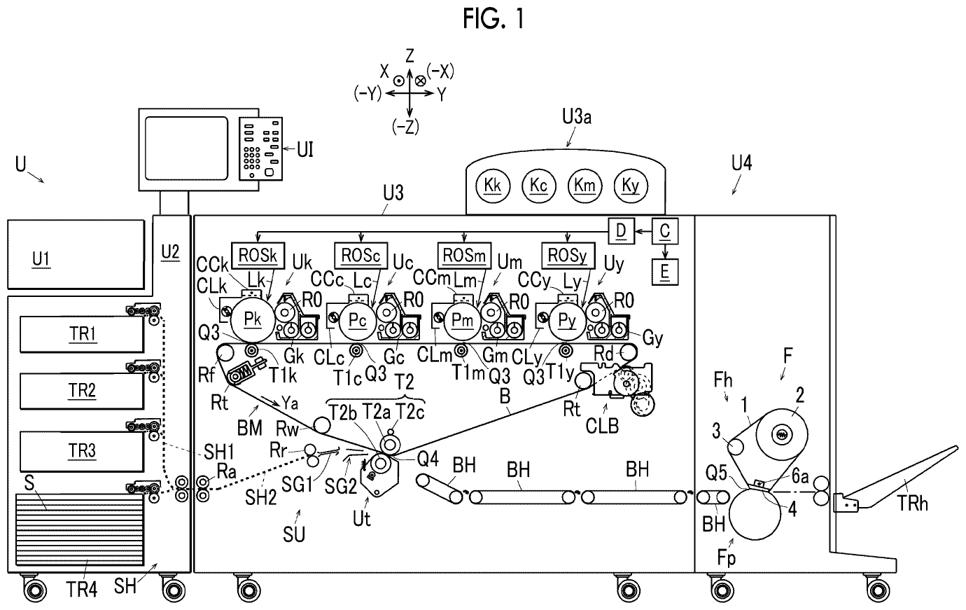

FIG. 1 is an overall view of an image forming apparatus according to Example 1 of the present invention.

In FIG. 1, a copying machine U as an example of an image forming apparatus includes a user interface UI as an example of an operation section, a scanner device U1 as an example of an image reading device, a sheet feed device U2, a printer unit U3 as an example of an image recording section, and a sheet discharge unit U4.

The user interface UI includes a power button or a copy start key, a number-of-copies setting key, a numeric keypad, and the like as an example of an input unit; a display unit; and the like.

The scanner device U1 reads an original document (not shown), converts read data into image information, and inputs the image information to the printer unit U3.

The sheet feed device U2 includes a plurality of sheet feed trays TR1, TR2, TR3, and TR4 as an example of a sheet feed unit. Recording sheets S as an example of mediums are stored in each of the sheet feed trays TR1 to TR4. A sheet feed passage SH1 as an example of a transport passage for a medium extends from each of the sheet feed trays TR1 to TR4 toward the printer unit U3.

In FIG. 1, the printer unit U3 includes a controller C as an example of a control unit, a power source circuit E that supplies power to each member of the printer unit U3, and the like. The controller C receives the image information of the original document read by the scanner device U1 and image information transmitted from a personal computer as an example of an information transmission device (not shown) connected to the copying machine U.

The controller C processes the received image information into printing information for Y (yellow), M (magenta), C (cyan), and K (black), and outputs the processed information to a laser drive circuit D as an example of a drive circuit of a latent image writing device. The laser drive circuit D outputs a laser drive signal, which is input from the controller C, to exposure devices ROSy, ROSm, ROSc, and ROSk as an example of latent image forming sections for the respective colors at preset times.

Image holder units Uy, Um, Uc, and Uk for Y, M, C, and K are disposed below the respective exposure devices ROSy to ROSk.

In FIG. 1, the image holder unit Uk for K (black) includes a photoreceptor drum Pk as an example of an image holding member, a charging corotron CCk as an example of a charging section, and a photoreceptor cleaner CLk as an example of a cleaning section for the image holding member. Further, the image holder units Uy, Um, and Uc for the other colors Y, M, and C also include photoreceptor drums Py, Pm, and Pc, charging corotrons CCy, CCm, and CCc, and photoreceptor cleaners CLy, CLm, and CLc.

Furthermore, in Example 1, the photoreceptor drum Pk for the K color of which the frequency of use is high and the surface is to be more worn is formed to have a larger diameter than the photoreceptor drums Py, Pm, and Pc for the other colors, so that high-speed rotation and a long service life are achieved.

After the photoreceptor drums Py to Pk are uniformly charged by the charging corotrons CCy to CCk, respectively, electrostatic latent images are formed on the surfaces of the photoreceptor drums Py to Pk by laser beams Ly, Lm, Lc, and Lk as an example of latent image writing light output from the exposure devices ROSy to ROSk. The electrostatic latent images formed on the surfaces of the photoreceptor drums Py to Pk are developed into toner images having the respective colors, that is, Y (yellow), M (magenta), C (cyan), and K (black) by developing devices Gy, Gm, Gc, and Gk as an example of developing sections.

The toner images formed on the surfaces of the photoreceptor drums Py to Pk are sequentially and overlappingly transferred onto an intermediate transfer belt B, which is an example of an intermediate transfer section and an example of an image holding member, in primary transfer regions Q3 by primary transfer rollers T1y, T1m, T1c, and T1k as an example of primary transfer sections, so that a multicolor image, that is, a so-called color image is formed on the intermediate transfer belt B. The color image formed on the intermediate transfer belt B is transported to a secondary transfer region Q4.

Further, in the case of only black image data, only the photoreceptor drum Pk for K (black) and the developing device Gk are used and only a black toner image is formed.

After the primary transfer, residual toner remaining on the surfaces of the photoreceptor drums Py to Pk is cleaned off by the photoreceptor cleaners CLy to CLk.

Each of the image holder units Uy to Uk and each of the developing devices Gy to Gk form a toner image forming member as an example of an image forming section.

A toner dispenser U3a as an example of a replenishment section is disposed on an upper portion of the printer unit U3, and toner cartridges Ky, Km, Kc, and Kk as an example of developer storage sections are attachably and detachably mounted on the toner dispenser U3a. In a case where toner is consumed in the developing devices Gy to Gk as images are formed, toner is supplied to each of the developing devices Gy to Gk from each of the toner cartridges Ky to Kk.

The intermediate transfer belt B disposed below the photoreceptor drums Py to Pk is stretched by an intermediate drive roller Rd as an example of a drive section for the intermediate transfer section, an intermediate tension roller Rt an example of a tension application member that applies tension to the intermediate transfer belt B, an intermediate steering roller Rw as an example of a first bias correction section that corrects bias or meandering of the intermediate transfer belt B, a plurality of intermediate idler rollers Rf as an example of driven sections, and a backup roller T2a as an example of a counter member in a secondary transfer region. Further, the intermediate transfer belt B is supported to be rotatable and movable in a direction of an arrow Ya by being driven by the intermediate drive roller Rd.

The intermediate drive roller Rd, the intermediate tension roller Rt, the intermediate steering roller Rw, the intermediate idler rollers Rf, the backup roller T2a, the primary transfer rollers T1y to T1k, the intermediate transfer belt B, and the like form a belt module BM as an example of an intermediate transfer device. Furthermore, the belt module BM of Example 1 is formed of a unit that is attachable to and detachable from the printer unit U3 or is replaceable in the printer unit U3.

A secondary transfer unit Ut as an example of a transfer/transport unit is disposed below the backup roller T2a. The secondary transfer unit Ut includes a secondary transfer roller T2b as an example of a transfer member. The secondary transfer roller T2b is disposed to face the backup roller T2a. The secondary transfer region Q4 is formed of a region where the secondary transfer roller T2b faces the intermediate transfer belt B. Further, a contact roller T2c as an example of a contact section, which is used to apply a voltage, is in contact with the backup roller T2a. A secondary transfer voltage having a polarity identical to the charging polarity of the toner is applied to the contact roller T2c from the power source circuit E controlled by the controller C at a preset time.

A secondary transfer device T2 as an example of a secondary transfer section is formed of the respective rollers T2a to T2c. Furthermore, a transfer device B+T1+T2 as an example of a transfer section is formed of the intermediate transfer belt B, the primary transfer rollers T1y to T1k, the secondary transfer device T2, and the like.

A sheet transport passage SH2 is disposed below the belt module BM. The recording sheet S fed from the sheet feed passage SH1 of the sheet feed device U2 is transported to the sheet transport passage SH2 by transport rollers Ra as an example of transport members. The recording sheet S transported to the sheet transport passage SH2 is fed by registration rollers Rr as an example of a feed sections according to a time when the toner image is transported to the secondary transfer region Q4, is guided by sheet guides SG1 and SG2 as an example of medium guide sections, and is transported to the secondary transfer region Q4.

The toner image on the intermediate transfer belt B is transferred onto the recording sheet S by the secondary transfer device T2 when passing through the secondary transfer region Q4. Meanwhile, in a case of a color image, the toner images overlappingly and primarily transferred onto the surface of the intermediate transfer belt B are collectively and secondarily transferred onto the recording sheet S.

The intermediate transfer belt B from which the toner images have been secondarily transferred is cleaned by a belt cleaner CLB as an example of a cleaning section for the intermediate transfer section.

The recording sheet S to which the toner images are secondarily transferred is sent to a medium transport belt BH as an example of a transport member. The medium transport belt BH transports the recording sheet S to a fixing device F that is an example of a belt unit and an example of a fixing section. The fixing device F includes a heating unit Fh as an example of a heating section and a pressure roller Fp as an example of a pressure section. A fixing region Q5 is formed of a region where the heating unit Fh and the pressure roller Fp face each other and are in contact with each other.

The toner images on the recording sheet S are heated and fixed by the fixing device F when passing through the fixing region Q5. The recording sheet S to which the toner images are fixed by the fixing device F is discharged to a discharge tray TRh as an example of a discharge part.

A sheet transport passage SH is formed of reference numerals SH1, SH2, and the like. Further, a sheet transport device SU is formed of reference numerals SH, Ra, Rr, SG1, SG2, BH, and the like.

### Description of Fixing Device

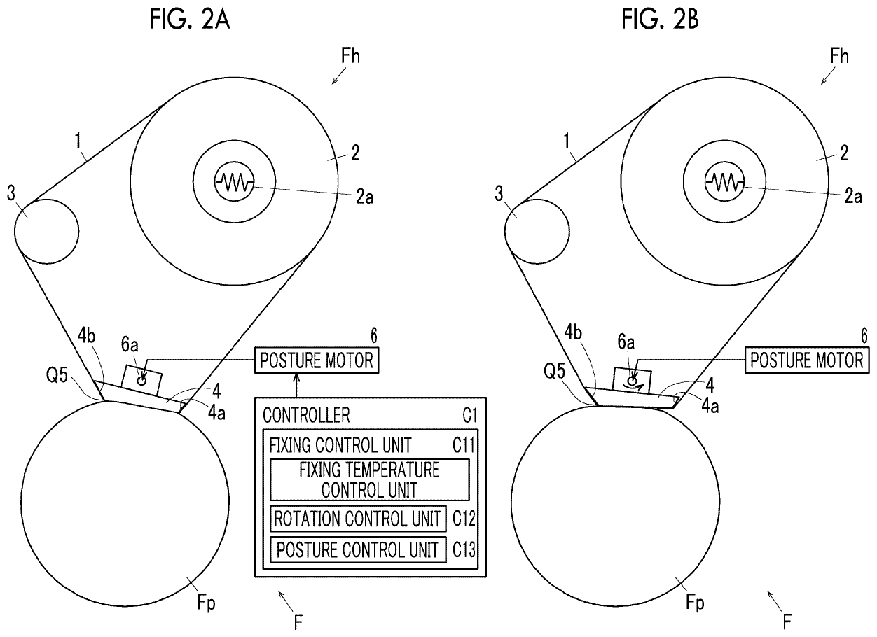

FIGS. 2A and 2B are enlarged views of the fixing device of Example 1 in which FIG. 2A is a diagram showing a state where a support member is moved to a first position and FIG. 2B is a diagram showing a state where the support member is moved to a second position.

In FIG. 1, the heating unit Fh of the fixing device F of Example 1 includes a fixing belt 1 as an example of an endless member. The fixing belt 1 is stretched by a heating roller 2 as an example of a rotating section, a steering roller 3 as an example of a bias correction section, and a heating pad 4 as an example of a support member.

The fixing belt 1 can be made of any material publicly known in the related art, and it is preferable that a substrate thereof is made of, for example, a polyimide-based material having high stiffness. Further, it is preferable that a surface layer of the fixing belt 1 is made of, for example, a material such as a fluororesin having high releasability of molten toner, paper powder, or the like.

A heater 2a as an example of a heating section is built in the heating roller 2 of Example 1. The heating roller 2 heated by the heater 2a heats the fixing belt 1 that is in contact with the heating roller 2.

The steering roller 3 corrects the meandering or bias of the fixing belt 1.

The heating pad 4 is disposed to face the pressure roller Fp as an example of a counter member. The fixing region Q5 is formed in a region between the fixing belt 1, which is supported by the heating pad 4, and the pressure roller Fp. Therefore, unfixed images on the recording sheet S passing through the fixing region Q5 are fixed to the recording sheet S by being pressed while being heated.

The heating pad 4 of Example 1 is disposed in a non-rotating state with respect to the fixing belt 1, unlike the heating roller 2 and the steering roller 3.

Further, a downstream end portion 4a and an upstream end portion 4b of the heating pad 4 of Example 1 in a rotation direction of the fixing belt 1 have different shapes. An angle between the upstream end portion 4b and a sheet transport direction is set to be smaller than an angle between the downstream end portion 4a and the sheet transport direction so that the recording sheet S is guided to the fixing region Q5. An angle between the downstream end portion 4a and the sheet transport direction is set to be large so that releasability between the recording sheet S having passed through the fixing region Q5 and the fixing belt 1 is improved. Therefore, the fixing belt 1 is supported in a posture in which a portion of the fixing belt 1 corresponding to the downstream end portion 4a is bent. In other words, a curvature radius of the portion of the fixing belt 1 corresponding to the downstream end portion 4a is smaller than a curvature radius of a portion of the fixing belt 1 corresponding to the upstream end portion 4b. That is, R is smaller at the downstream end portion 4a and is larger at the upstream end portion 4b. Therefore, the posture of the fixing belt 1 is changed at a sharp angle at the downstream end portion 4a.

The heating pad 4 of Example 1 is rotatably supported about a rotating shaft 6a extending in a width direction of the fixing belt 1. The heating pad 4 is rotated as a posture motor 6 as an example of a posture changing section is driven. The heating pad 4 of Example 1 is movable between a fixing position as an example of the first position shown in FIG. 2A and a bending reduction position as an example of the second position shown in FIG. 2B. At the fixing position shown in FIG. 2A, the heating pad 4 brings the fixing belt 1 into contact with the pressure roller Fp at a predetermined contact pressure. At the bending reduction position shown in FIG. 2B, the heating pad 4 is rotated in a direction in which the downstream end portion 4a is separated from the fixing belt 1. Therefore, at the bending reduction position, the heating pad 4 is in a posture in which the bending of a bent portion of the fixing belt 1 (the portion of the fixing belt 1 corresponding to the downstream end portion 4a) is reduced as compared to the bending of the bent portion at the fixing position.

In Example 1, the downstream end portion 4a is not completely separated from the fixing belt 1 at the bending reduction position. Therefore, a contact pressure between the downstream end portion 4a and the fixing belt 1 at the bending reduction position is reduced as compared to the contact pressure at the fixing position. In an aspect in which the downstream end portion 4a is not completely separated from the fixing belt 1, the posture of the entire fixing belt 1 is changed a little from the posture of the entire fixing belt 1 at the fixing position. Therefore, a failure such as the fixing belt 1 falling off from the heating pad 4 in an unexpected situation such as external vibration is likely to be suppressed.

The present invention is not limited to the aspect in which the downstream end portion 4a is not completely separated from the fixing belt 1. For example, the downstream end portion 4a may be completely separated from the fixing belt 1 at the bending reduction position. In a case where the downstream end portion 4a is completely separated from the fixing belt 1, an effect of reducing bending is higher than in a case where the downstream end portion 4a is not completely separated from the fixing belt 1.

### Description of Controller of Example 1

In FIGS. 2A and 2B, the controller C of the copying machine U includes an input/output interface I/O that inputs and outputs signals to and from the outside. Further, the controller C includes a read-only memory (ROM) in which a program, information, and the like used for necessary processing are stored. Furthermore, the controller C includes a random access memory (RAM) that temporarily stores necessary data. In addition, the controller C includes a central processing unit (CPU) that performs processing corresponding to the program stored in the ROM or the like. Accordingly, the controller C of Example 1 is formed of a small information processing device (a so-called microcomputer). Therefore, the controller C can realize various functions by executing the program stored in the ROM or the like.

Signals from a signal output element are input to the controller C of Example 1 and the controller C outputs signals to control target elements to control the control target elements.

### Functions of Controller C

The controller C of Example 1 includes the following functional sections (functional modules, program modules).

A fixing control unit C1 includes a fixing temperature control unit C11, a rotation control unit C12, and a posture control unit C13. The fixing control unit C1 controls the operation and stop of the fixing device F.

The fixing temperature control unit C11 controls ON/OFF of the heater 2a to maintain the temperature of the fixing belt 1 at a predetermined fixing temperature. The fixing temperature control unit C11 starts the control of the heater 2a such that the temperature of the fixing belt reaches the fixing temperature in a case where a job, which is an image forming operation, is started. In a case where the job ends, the fixing temperature control unit C11 turns off the heater 2a.

The rotation control unit C12 controls the rotation of the pressure roller Fp. Therefore, the rotation of the fixing belt 1 to be rotated is also indirectly controlled as the rotation of the pressure roller Fp is controlled. The rotation control unit C12 of Example 1 drives the pressure roller Fp in a case where the job is started, and stops the pressure roller Fp in a case where the job ends.

The posture control unit C13 controls the posture motor 6 to move the heating pad 4 between the fixing position and the bending reduction position. The posture control unit C13 moves the heating pad 4 to the fixing position in a case where the job is started. In a case where the job ends and the rotation of the fixing belt 1 ends, the posture control unit C13 moves the heating pad 4 to the bending reduction position.

A case where a time when the heating pad 4 is to be moved is matched with the start and end of the job has been exemplified in Example 1, but the present invention is not limited thereto. For example, it is also possible to move the heating pad 4 with a margin from the start or end of the job. Further, the heating pad 4 can be held at the fixing position for a certain time after the job ends, that is, in a so-called standby state. Then, after a certain time has passed, that is, when a so-called sleep state is made, the heating pad 4 can be moved to the bending reduction position. The rotation of the fixing belt 1 may be based on the posture of the fixing belt 1 that is supported by the heating pad 4. Accordingly, in a case where the fixing belt 1 is rotated in a state where the heating pad 4 is moved to the bending reduction position, the rotation of the fixing belt 1 may be unstable. Therefore, it is preferable that the heating pad 4 is moved, for example, after the fixing belt 1 is stopped and before the rotation of the fixing belt 1 is started. Therefore, it is also possible to move the heating pad 4 simultaneously with the stop of the fixing belt 1, or to move the heating pad 4 when a certain time has passed after the stop of the fixing belt 1.

### Action of Example 1

In the fixing device F of Example 1 having the above-described configuration, in a case where an image forming operation (job) is started, the fixing belt 1 is heated and developers on the surface of the recording sheet S passing through the fixing region Q5 are heated, melted, and fixed.

In a case where the job is started, the heating pad 4 is moved to the fixing position. Therefore, a contact pressure, which is one of fixing conditions in the fixing region Q5, is maintained at a predetermined contact pressure. Further, in a state where the heating pad 4 is moved to the fixing position, the fixing belt 1 smoothly guides the recording sheet S to the fixing region Q5 at the portion of the fixing belt 1 corresponding to the upstream end portion 4b of the heating pad 4. Furthermore, the recording sheet S is easily released from the fixing belt 1 at the portion of the fixing belt 1 corresponding to the downstream end portion 4a of the heating pad 4. That is, the adhesion of the recording sheet S, which has been subjected to fixing, to the fixing belt 1 is suppressed.

In a case where the job ends and the rotation of the fixing belt 1 is stopped, the heating pad 4 is moved to the bending reduction position. In a case where the heating pad 4 is moved to the bending reduction position, a force applied to the fixing belt 1 from the downstream end portion 4a of the heating pad 4 is released and reduced. Therefore, the bending of the portion of the fixing belt 1 corresponding to the downstream end portion 4a of the heating pad 4 is eased. Then, until the next job is started, the heating pad 4 is held at the bending reduction position and a state where the bending of the fixing belt 1 is eased is held.

A contact pressure between the heating belt and the pressure belt is eased in the technique disclosed in JP2011-81079A, but the posture of the belt itself is not changed. For this reason, the belt may have a tendency to be bent during rotation stop. In a case where the belt has a tendency to be bent, a bent portion is straightened when passing through the position of the heating roller 2 or the fixing region Q5. For this reason, the belt receives a physical load. Therefore, since a force by which the belt is in contact with the heating roller 2 or the pressure roller Fp is locally increased, poor fixing may occur or damage such as scratches will occur. Further, in a case where the tendency of the belt to be bent and the straightening of the belt are repeated, wear with time, such as fatigue and deterioration, also occurs. For this reason, there is also a problem that the life of a product is shortened.

In the technique disclosed in JP2020-71350A, the tendency of the belt to be bent is relieved but the fixing device is periodically operated even though images are not formed. Therefore, in the technique disclosed in JP2020-71350A, there is a problem that an electric bill or the like is generated during operation or parts are worn out due to operation. In addition, since an operation sound is generated in a case where the fixing device is operated even though a user does not form images, the user may misunderstand that the fixing device is out of order.

In contrast, in the fixing device F of Example 1, the heating pad 4 is moved to the bending reduction position only at the time of the end of the job. Therefore, the tendency of the fixing belt 1 to be bent is suppressed as compared to a case where the posture of the fixing belt 1 is fixed at the time of the stop of the rotation of the fixing belt 1. Further, as in JP2020-71350A, the fixing device F is not operated periodically, and the heating pad 4 is merely held at the bending reduction position and merely returns to the fixing position at the time of the next job. Therefore, problems such as an increase in cost, the wear of parts, and an operation sound can also be addressed.

### Example 2

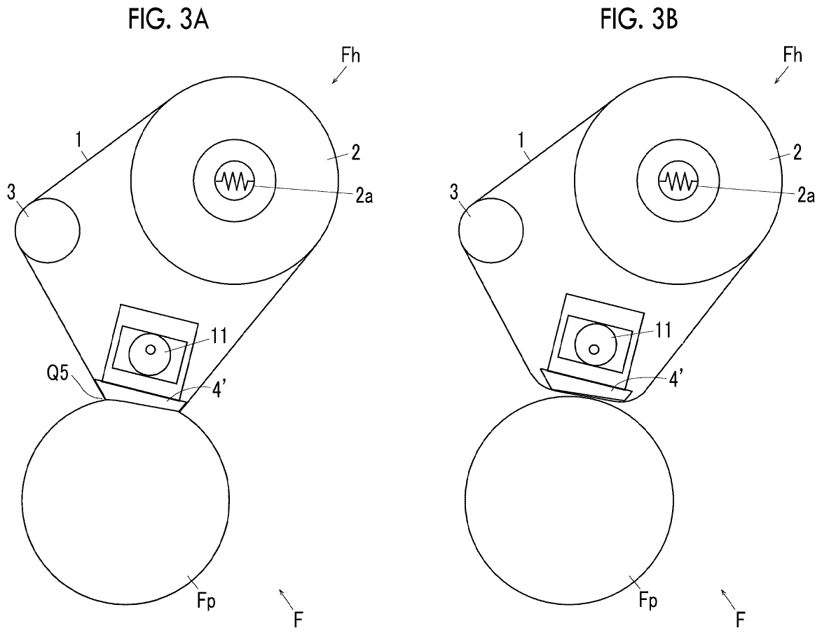

FIGS. 3A and 3B are enlarged views of a fixing device of Example 2 corresponding to FIGS. 2A and 2B of Example 1 in which FIG. 3A is a diagram showing a state where a support member is moved to a first position and FIG. 3B is a diagram showing a state where the support member is moved to a second position.

Next, Example 2 of the present invention will be described. The components identical to components in Example 1 will be denoted by the identical reference numerals, and detailed description thereof will be omitted.

In FIGS. 3A and 3B, the entire heating pad 4′ of Example 2 is supported to be movable in a direction in which the heating pad 4′ approaches and is separated from a center of a pressure roller Fp, unlike the heating pad 4 of Example 1. The heating pad 4′ is moved in a direction in which the heating pad 4′ approaches or is separated from the pressure roller Fp as an eccentric cam 11 as an example of a posture changing section is rotated. The heating pad 4′ of Example 2 is movable between a fixing position as an example of the first position shown in FIG. 3A and a bending reduction position as an example of the second position shown in FIG. 3B. At the fixing position shown in FIG. 3A, the heating pad 4′ brings the fixing belt 1 into contact with the pressure roller Fp at a predetermined contact pressure. At the bending reduction position shown in FIG. 3B, the heating pad 4′ is moved to a position separated from the center of the pressure roller Fp as compared to at the fixing position.

A time when the heating pad 4′ of Example 2 is moved between the fixing position and the bending reduction position is set in a manner identical to the manner in Example 1. Further, in Example 2, a posture control unit C13 controls the rotation of the eccentric cam 11 to control the movement of the heating pad 4′.

Furthermore, in Example 2, the heating pad 4′ is completely separated from the fixing belt 1 at the bending reduction position. However, the present invention is not limited to an aspect in which the heating pad 4′ is completely separated from the fixing belt 1. For example, at the bending reduction position, the heating pad 4′ may not be completely separated from the fixing belt 1 and a contact pressure between the heating pad 4′ and the fixing belt 1 may be reduced as compared to the contact pressure at the fixing position.

### Action of Example 2

In the fixing device F of Example 2 having the above-described configuration, the heating pad 4′ is moved to the bending reduction position after the rotation of the fixing belt 1 is stopped. Therefore, even in the fixing device F of Example 2, the tendency of the fixing belt 1 to be bent is suppressed as in Example 1.

### Example 3

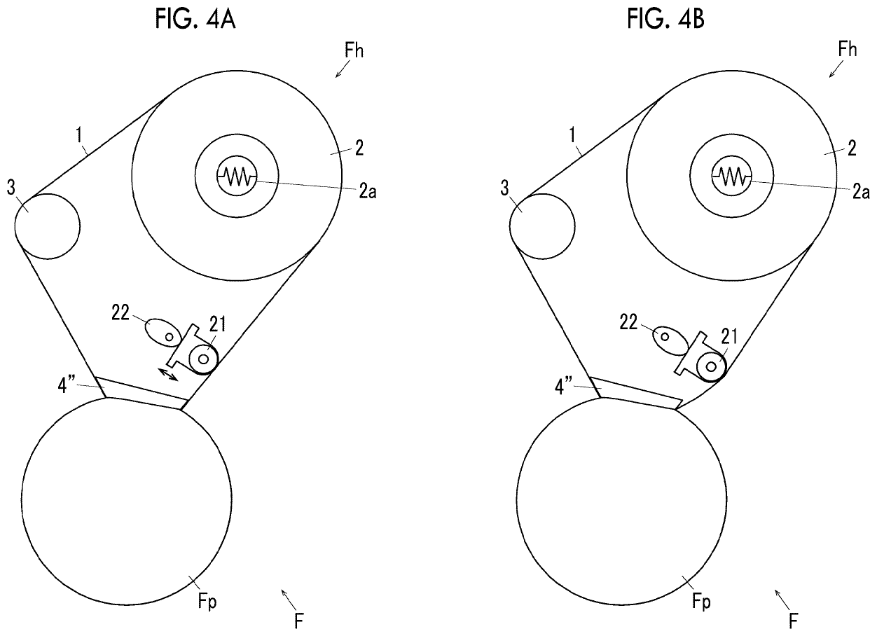

FIGS. 4A and 4B are enlarged views of a fixing device of Example 3 corresponding to FIGS. 2A and 2B of Example 1 in which FIG. 4A is a diagram showing a state where a posture changing section is moved to a first position and FIG. 4B is a diagram showing a state where the posture changing section is moved to a second position.

Next, Example 3 of the present invention will be described. The components identical to components in Example 1 will be denoted by the identical reference numerals, and detailed description thereof will be omitted.

In FIGS. 4A and 4B, a posture changing roller 21 as an example of a posture changing section is disposed between a heating pad 4″ and a heating roller 2 in a fixing device F of Example 3. Meanwhile, unlike in Example 1, the heating pad 4″ is not moved in Example 3.

The posture changing roller 21 is disposed inside the fixing belt 1. The posture changing roller 21 is supported to be movable in a direction in which the posture changing roller 21 is in contact with and is separated from an inner surface of the fixing belt 1. The posture changing roller 21 is moved in a direction in which the posture changing roller 21 is in contact with and is separated from the fixing belt 1 as an eccentric cam 22 as an example of an operation section is rotated. The posture changing roller 21 of Example 3 is movable between a fixing position as an example of the first position shown in FIG. 4A and a bending reduction position as an example of the second position shown in FIG. 4B. At the fixing position shown in FIG. 4A, the posture changing roller 21 is separated from the inner surface of the fixing belt 1. At the bending reduction position shown in FIG. 4B, the posture changing roller 21 pushes the inner surface of the fixing belt 1 to the outside. Therefore, the posture of the fixing belt 1 is changed to a posture in which the bending of a bent portion of the fixing belt 1 corresponding to a downstream end portion 4a of the heating pad 4″ is reduced.

In Example 3, the posture changing roller 21 is completely separated from the fixing belt 1 at the fixing position. However, the present invention is not limited to an aspect in which the posture changing roller 21 is completely separated from the fixing belt 1. For example, at the fixing position, the posture changing roller 21 may not be completely separated from the fixing belt 1 and a contact pressure between the posture changing roller 21 and the fixing belt 1 may be reduced as compared to the contact pressure at the bending reduction position.

In Example 3, a posture control unit C13 controls the rotation of the eccentric cam 22 to control the movement of the posture changing roller 21.

### Action of Example 3

In the fixing device F of Example 3 having the above-described configuration, the posture changing roller 21 is moved to the bending reduction position after the rotation of the fixing belt 1 is stopped. Therefore, even in the fixing device F of Example 3, the tendency of the fixing belt 1 to be bent is suppressed as in Example 1.

### Modification Examples

Examples of the present invention have been described in detail above, but the present invention is not limited to Examples described above and can have various modifications without departing from the scope of the present invention described in claims. Modification examples (H01) to (H07) of the present invention will be exemplified below.

(H01) The copying machine U as an example of the image forming apparatus has been exemplified in Examples described above, but the present invention is not limited thereto. For example, the image forming apparatus can also be formed of FAX, a printer, and a multifunction machine.

(H02) A configuration in which developers for four colors are used has been exemplified as the image forming apparatus in Examples described above, but the present invention is not limited thereto. For example, the present invention can also be applied to a monochromatic image forming apparatus, and an image forming apparatus for multiple colors of three colors or less or five colors or more.

(H03) In Examples described above, the shapes of the downstream end portions 4a and the upstream end portions 4b of the heating pads 4, 4′, and 4″ are not limited to the shapes illustrated in Examples. The downstream end portion 4a can also have a shape identical to the shape of the upstream end portion 4b. Conversely, the upstream end portion 4b can also have a shape identical to the shape of the downstream end portion 4a. In this case, the heating pads 4 and 4′ are moved in a direction in which a portion where bending to be reduced occurs is separated from the fixing belt 1, so that the bending is reduced.

(H04) An aspect in which the heater 2a as a heating section is built in the heating roller 2 has been exemplified in Examples described above, but the present invention is not limited thereto. The heater 2a may also be built in the heating pads 4, 4′, and 4″.

(H05) The fixing device F has been exemplified as the belt unit in Examples described above, but the present invention is not limited thereto. For example, the image forming apparatus may include belts such as an intermediate transfer belt, a photoreceptor belt, a transfer/transport belt, and a secondary transfer belt, and the present invention can be applied to any belt unit in which a problem of scratches is raised.

(H06) An aspect in which the pressure roller Fp is driven to rotate the fixing belt 1 has been exemplified in Examples described above, but the present invention is not limited thereto. The present invention can also be applied to a configuration in which the fixing belt 1 is driven to rotate the pressure roller Fp. The present invention can also be applied to a case where a pressure belt is used instead of the pressure roller Fp.

(H07) The posture changing roller 21 of Example 3 may be added to Examples 1 and 2 in the above-described examples.

### Supplementary Note

(((1)))

A belt unit comprising:
an endless member that is rotated;
a support member that supports the endless member in a bent posture at an end portion of the support member in a rotation direction of the endless member;
a counter member that is disposed to face the support member with the endless member interposed therebetween and is in contact with the endless member at a predetermined contact pressure;
a posture changing section that changes a posture of a bent portion of the endless member; and
a control unit that controls the posture changing section to change a posture of the endless member to a posture in which bending of the bent portion of the endless member is reduced in a case where rotation of the endless member ends.

(((2)))

The belt unit according to (((1))),
wherein the support member supports the endless member at a downstream end of the support member in the rotation direction of the endless member in a posture in which bending of the endless member is larger than bending of the endless member at an upstream end of the support member.

(((3)))

The belt unit according to (((2))),
wherein the posture changing section moves the downstream end of the support member in a direction in which the downstream end is separated from the endless member to change the posture of the bent portion of the endless member.

(((4)))

The belt unit according to (((1))),
wherein the posture changing section moves the support member in a direction in which the support member is separated from the counter member to change the posture of the bent portion of the endless member.

(((5)))

The belt unit according to (((4))),
wherein the posture changing section is capable of moving the support member to a position where the support member is separated from the endless member.

(((6)))

The belt unit according to any one of (((1))) to (((5))),
wherein the posture changing section is disposed downstream of the bent portion of the endless member in the rotation direction of the endless member, and comes into contact with the endless member and changes a posture of the endless member to change the posture of the bent portion of the endless member.

(((7)))

The belt unit according to any one of (((1))) to (((6))),
wherein the belt unit is formed of a fixing device that fixes an unfixed image on a surface of a medium with heat of a heating section and a contact pressure between the endless member and the counter member when the medium passes between the endless member and the counter member.

(((8)))

An image forming apparatus comprising:
an image holding member that holds an image on a surface of the image holding member;
a transfer section that transfers the image held on the image holding member onto a medium; and
the belt unit according to (((7))) that fixes the image transferred onto the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A belt unit comprising:
an endless member that is rotated;
a support member that supports the endless member in a bent posture at an end portion of the support member in a rotation direction of the endless member;
a counter member that is disposed to face the support member with the endless member interposed therebetween and is in contact with the endless member at a predetermined contact pressure;
a posture changing section that changes a posture of a bent portion of the endless member; and
a control unit that controls the posture changing section to change a posture of the endless member to a posture in which bending of the bent portion of the endless member is reduced in a case where rotation of the endless member ends.

2. The belt unit according to claim 1,
wherein the support member supports the endless member at a downstream end of the support member in the rotation direction of the endless member in a posture in which bending of the endless member is larger than bending of the endless member at an upstream end of the support member.

3. The belt unit according to claim 2,
wherein the posture changing section moves the downstream end of the support member in a direction in which the downstream end is separated from the endless member to change the posture of the bent portion of the endless member.

4. The belt unit according to claim 1,
wherein the posture changing section moves the support member in a direction in which the support member is separated from the counter member to change the posture of the bent portion of the endless member.

5. The belt unit according to claim 4,
wherein the posture changing section is capable of moving the support member to a position where the support member is separated from the endless member.

6. The belt unit according to claim 1,
wherein the posture changing section is disposed downstream of the bent portion of the endless member in the rotation direction of the endless member, and comes into contact with the endless member and changes a posture of the endless member to change the posture of the bent portion of the endless member.

7. The belt unit according to claim 1,
wherein the belt unit is formed of a fixing device that fixes an unfixed image on a surface of a medium with heat of a heating section and a contact pressure between the endless member and the counter member when the medium passes between the endless member and the counter member.

8. The belt unit according to claim 2,
wherein the belt unit is formed of a fixing device that fixes an unfixed image on a surface of a medium with heat of a heating section and a contact pressure between the endless member and the counter member when the medium passes between the endless member and the counter member.

9. The belt unit according to claim 3,
wherein the belt unit is formed of a fixing device that fixes an unfixed image on a surface of a medium with heat of a heating section and a contact pressure between the endless member and the counter member when the medium passes between the endless member and the counter member.

10. The belt unit according to claim 4,
wherein the belt unit is formed of a fixing device that fixes an unfixed image on a surface of a medium with heat of a heating section and a contact pressure between the endless member and the counter member when the medium passes between the endless member and the counter member.

11. The belt unit according to claim 5,
wherein the belt unit is formed of a fixing device that fixes an unfixed image on a surface of a medium with heat of a heating section and a contact pressure between the endless member and the counter member when the medium passes between the endless member and the counter member.

12. The belt unit according to claim 6,
wherein the belt unit is formed of a fixing device that fixes an unfixed image on a surface of a medium with heat of a heating section and a contact pressure between the endless member and the counter member when the medium passes between the endless member and the counter member.

13. An image forming apparatus comprising:
an image holding member that holds an image on a surface of the image holding member;
a transfer section that transfers the image held on the image holding member onto a medium; and
the belt unit according to claim 7 that fixes the image transferred onto the medium.

14. An image forming apparatus comprising:
an image holding member that holds an image on a surface of the image holding member;
a transfer section that transfers the image held on the image holding member onto a medium; and
the belt unit according to claim 8 that fixes the image transferred onto the medium.

15. An image forming apparatus comprising:
an image holding member that holds an image on a surface of the image holding member;
a transfer section that transfers the image held on the image holding member onto a medium; and
the belt unit according to claim 9 that fixes the image transferred onto the medium.

16. An image forming apparatus comprising:
an image holding member that holds an image on a surface of the image holding member;
a transfer section that transfers the image held on the image holding member onto a medium; and
the belt unit according to claim 10 that fixes the image transferred onto the medium.

17. An image forming apparatus comprising:
an image holding member that holds an image on a surface of the image holding member;
a transfer section that transfers the image held on the image holding member onto a medium; and
the belt unit according to claim 11 that fixes the image transferred onto the medium.

18. An image forming apparatus comprising:
an image holding member that holds an image on a surface of the image holding member;
a transfer section that transfers the image held on the image holding member onto a medium; and
the belt unit according to claim 12 that fixes the image transferred onto the medium.

19. A belt unit comprising:
an endless member that is rotated;
a support member that supports the endless member in a bent posture at an end portion of the support member in a rotation direction of the endless member;
a counter member that is disposed to face the support member with the endless member interposed therebetween and is in contact with the endless member at a predetermined contact pressure;
a posture changing section that changes a posture of a bent portion of the endless member; and
a control unit that controls the posture changing section to change a posture of the endless member to a posture in which bending of the bent portion of the endless member is reduced in a case where rotation of the endless member ends.
